(19) United States
(12) Patent Application Publication
(10) Pub. No.: US 2008/0005129 A1
(43) Pub. Date: Jan. 3, 2008

(54) System for creating dynamic web pages

(75) Inventor: Harald Herberth, Oberasbach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/810,239

(22) Filed: Jun. 5, 2007

(30) Foreign Application Priority Data
Jun. 9, 2006 (EP) 06011931.0

(51) Int. Cl. G06F 17/30

(52) U.S. Cl. 707/10

(57) ABSTRACT

There is described a programmable logic controller system and a method for the automated creation of a dynamic web page, comprising a server for the administration of the dynamic web page, an application program for the provision of the dynamic web page and an operating system as an interface for the transmission of data between the server and the application program. Identification parameters of the dynamic web page can be sent by a web browser via the server and hence into the operating system. To determine the identification parameters sent to the operating system, a first request is sent to the operating system. According to the result of this determination, the identification parameters can be forwarded by the operating system into the application program. Based on the identification parameters, the dynamic web page is provided by the application program using a programming language of the control system and transmitted to the server via the operating system.

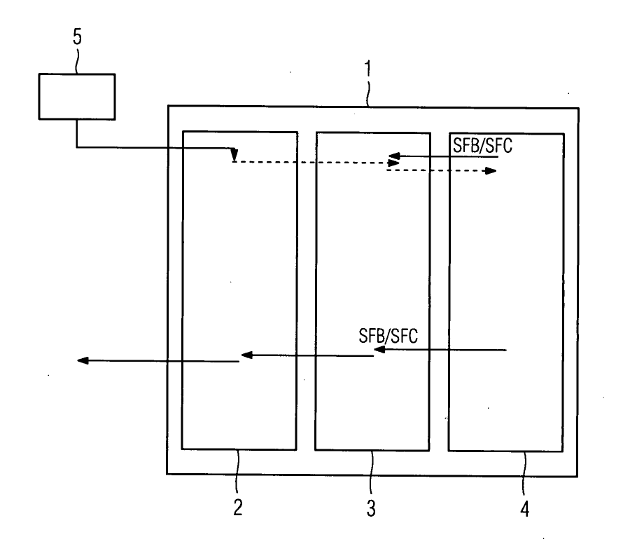

### CROSS REFERENCE TO RELATED APPLICATIONS

This application claims priority of European application No. 06011931.0 EP filed Jun. 9, 2006, which is incorporated by reference herein in its entirety.

### FIELD OF INVENTION

The invention relates to a system or a method for the automated creation of dynamic web pages.

### BACKGROUND OF INVENTION

By dynamic web pages or dynamically created web pages is understood that the actual content of a web page is first generated or created by the visit of an internet surfer. The content of the web page can be created dynamically, i.e. at the moment the request is made by a web browser and does not have to be statically available (i.e. in the form of an HTML page) to web servers. Thereby it is already known that a web server has been used in a programmable logic controller (PLC). With web servers of this kind it must also be programmed or projected what information should be offered by the web pages. A web server program is written in a programming language, which is usually Java, C/C++, PHP (Personal Home Page tools), Perl and others or communication mechanisms in web applications. But programming languages of this kind are not available for an PLC application. As in most cases the people who specify the contents and functionality of the web application do not also possess the necessary technological knowledge to implement PLC, there must be cooperation with other people. This can negatively affect the quality of the work result. Moreover, by virtue of their characteristics, dynamic web pages must place greater demands on the efficiency of the web server.

It is further known that CGI interfaces (Common Gateway Interface) can be used to generate dynamic web pages. Thereby, programs can be executed on a web server via CGI interfaces. Such a program can be written in all kinds of programming languages, thereby it must be compiled for the operating system of the web server. The CGI execution is relatively slow, as a new program instance must be executed for each CGI invocation. It is for that reason that CGI is nowadays no longer used so often.

### SUMMARY OF INVENTION

An object underlying the invention is the automated creation of dynamic web pages in a programming language of a PLC system.

According to the invention, this object is achieved by a programmable logic controller system with the features of an independent claim or by a method with the features of a further independent claim. The dependent claims relate to advantageous developments and embodiments of the control system or of the method.

The invention is based on the idea that dynamic web pages can be created by a combination of web applications and control programming. A dynamic web page, which is requested or invoked by a web browser, is automatically created by a programmable logic controller systems (PLC system), whereby the PLC system comprises a server for the administration of the dynamic web page, an application program for the provision of the dynamic web page and an operating system as an interface for the transmission of data between the server and the application program. A user can start a web application, by inputting for example the URL (Uniform Resource Locator) of a dynamic web page in the web browser and thus sending a request to the web page. The server receives this request and transfers it to the operating system by forwarding the identification parameters (Cookies, URL or http request) of the requested web page transmitted by the web browser to the server into the operating system. In order to determine the identification parameters sent to the operating system, a first request is sent by the application program to the operating system, and according to the result of this determination, the identification parameters can be forwarded into the application program by the operating system. The first request can be realized, for example, by an operating system request (SFB/SFC). If, by the first request, it is determined that the web page was requested by the web browser, the identification parameters of the web page are forwarded into the application program. Based on the identification parameters, this web page is provided by the application program using a programming language of the control system. Subsequently the dynamic web page provided is transmitted to the server via the operating system, so that the server can send this web page to the web browser. This requested web page is then displayed to the user by the web browser. A very big advantage of dynamic web pages created in this way is that the user has the possibility of being able to create his web application in a programming language that he knows. He can then create dynamic web pages in particular with a PLC programming language. In this inventive PLC system, the creation of dynamic web pages does not place any greater demands on the efficiency of the web server, because this creation is done outside the server.

As a rule, the dynamic web page has at least one static part and one dynamic part, whereby the static part can be stored in the control system, subsequently it is possible to create only the dynamic part of the requested web page in real time. This allows the server load and the demands on the storage capacity of the server to be reduced.

According to an advantageous embodiment of the invention, the data of the dynamic part is determined by the control system. Thereby one can introduce the data, which is currently stored in an operand area of the control system, into the dynamic part. The stored static part and the determined dynamic part are combined by the application program to provide the web page, i.e. the web application and control program can be created together, this also makes it easier to keep the data consistent. The dynamic web page is usually provided as an HTML web page by the application program, so that the web page created is sent directly to the server.

According to a further advantageous embodiment of the invention, the dynamic web page contains at least one marker (e.g. tag) to identify a replaceable location on the dynamic web page. At this location, when the HTML page is requested a current value read directly from the control system can be inserted or updated. As a rule, such dynamic web pages are created in a markup language (e.g. HTML), indexed with URL and stored in a database. As a result a function library can be offered for the control system, which library can further simplify the creation of the web pages for the user. Now when there is a request for a web page, which was invoked by a URL, the function library can, without further programming, locate the appropriate web page for this URL and replace the markers of the web page by current process data so that a dynamic web page can be provided.

According to a further advantageous embodiment of the invention, the first request is sent cyclically by the application program to the operating system. As a result of that, a second request for sending the dynamic web page provided to the operating system is sent by the application program to the operating system, as a result of that a data transmission can be directly established between the operating system and the application program. The second request can also be enabled by an operating system invocation (SBF/SFC). Thereby the identification parameters of the requested web page can be transmitted to the application program as a function of the first request and the web page provided sent to the server as a function of the second request.

### BRIEF DESCRIPTION OF THE DRAWING

In the following, the invention is described and explained in more detail using the exemplary embodiment shown in a sole FIGURE.

The FIGURE shows a programmable logic controller system for the automated creation of a dynamic web page.

### DETAILED DESCRIPTION OF INVENTION

The sole FIGURE shows a programmable logic controller system 1 for the automated creation of a dynamic web page, which was requested by a web browser 5. Thereby the control system 1 comprises a server 2 for the administration of the dynamic web page, an application program 4 for the provision of the dynamic web page and an operating system 3, whereby the operating system 3 serves as an interface for the transmission of data between the server 2 and the application program 4. This allows data, such as, for example, URL addresses, to be transmitted by users through the inputs effected (http post) or parameters of links (http get).

A user invokes a dynamic web page by inputting a URL address (Uniform Resource Locator) in the web browser 5. That means that the web browser 5 sends a request (http Request) to the server. The server 2 can process this request, whereby the communication between the web browser 5 and the server 2 is controlled by a text based HTTP protocol. The HTTP protocol is used for addressing the requested web page via URL address, it handles the interaction between the web browser 5 and the server 2. The server 2 receives this request and transmits said request on to the operating system 3 by sending the URL address (identification parameters) transmitted by the web browser 5 to the server 2 into the operating system 3. An operating system invocation (SFB/SFC) is sent cyclically by the application program 4 to the operating system 3 and queries whether the identification parameters (e.g. Cookies, URL or http request) have been sent to the operating system 3. If this is the case, the identification parameters (here the URL address) are forwarded from the operating system 3 into the application program 4.

Based on this URL address, the dynamic web page is made available by the application program 4 by means of a programming language of the control system 1. These programming languages can be the application programming languages based on the control system such as, for example, AWL (Instruction List) or SCL (Structured Control Language). If the dynamic web page has a static part and a dynamic part, the static part can be created with an HTML language and stored in a database, while the data of the dynamic part is retrieved from an operand area of the control system 1. The static part and the dynamic part are combined by the application program 4 for the provision of the dynamic web page and usually provided as an HTML web page. Subsequently this dynamic web page provided is sent by the application program 4 to the server 2 via the operating system 3. Finally the web page provided is sent by the server 2 to the web browser 5 (http Response). The web browser 5 shows the dynamic web page accordingly graphically.

By means of this control system 1, a user, who specifies technical knowledge for implementing PLC, but at the same time does not have the contents and functionality of the web application, can create a web application in an PLC programming language that he knows. In this control system 1 high demands are not placed on the efficiency of the server 2, because the creation of the web page is carried out outside the server. By this means, the view of the current values and the operation of the control system 1 through changing the values is possible through the web browser 5. In addition, a separate web page can be created for each device that is controlled by the control system 1.

1.-12. (canceled)

13. A programmable logic controller system, comprising:
a server for administration of a dynamic web page;
an application program to provide of the dynamic web page, wherein the dynamic web page is created via the programmable logic controller system, and wherein the dynamic web page is requested and displayed via a web browser;
an operating system for a transmission of data between the server and the application program;
identification parameters of the requested dynamic web page, wherein the identification parameters are sent by the web browser via the server into the operating system, wherein for the determination of the identification parameters sent to the operating system a first request is sent from the application program to the operating system, and wherein the identification parameters are forwarded by the operating system into the application program; and
a programming language to provide the dynamic web page based upon the application program and the identification parameters, wherein the dynamic web page is transmitted via the operating system to the server.

14. The programmable logic controller system as claimed in claim 13, wherein the dynamic web page has a static part and a dynamic part, wherein the static part is stored in the control system.

15. The programmable logic controller system as claimed in claim 13, wherein the data of the dynamic parts are determined by the control system.

16. The programmable logic controller system as claimed in claim 13, wherein the dynamic web page has marker to be replaced by a dynamic value of the control system.

17. The programmable logic controller system as claimed in claim 13, wherein the first request is sent cyclically by the application program to the operating system.

18. The programmable logic controller system as claimed in claim 13, wherein a second request is sent by the application program to the operating system to send the dynamic web page provided to the operating system.

19. The programmable logic controller system as claimed in claim 13, wherein the identification parameters are forwarded by the operating system into the application program based upon a result of the determination of the identification parameters sent to the operating system.

20. A method for an automated creation of a dynamic web page, comprising:
providing the dynamic web page by an application program;
requesting the dynamic web page by the web browser;
displaying the dynamic web page by the web browser;
administering the dynamic web page by a server;
transmitting data between the server and the application program by an operating system;
determining identification parameters of the requested dynamic web page based upon a request sent to the operating system;
sending identification parameters by the web browser via the server to the operating system;
transmitting the identification parameters by the operating system to the application program;
providing the dynamic web page by the application program using a programming language of the control system, wherein the dynamic web page is based upon the identification parameters; and
transmitting the dynamic web page provided to the server via the operating system.

21. The method as claimed in claim 20, wherein the operating system transmits data as an interface.

22. The method as claimed in claim 20, wherein the dynamic web page has a static part and a dynamic part, wherein the static part is stored in the control system.

23. The method as claimed in claim 20, wherein the data of the dynamic part is determined by the control system.

24. The method as claimed in claim 20, wherein the dynamic web page contains at least one marker to be replaced with a dynamic value of the control system.

25. The method as claimed in claim 20, wherein the request is sent cyclically by the application program to the operating system.

26. The method as claimed in claim 20, wherein a further request is sent by the application program to the operating system to send the dynamic web page to the operating system.

27. The method as claimed in claim 20, wherein the programming language of the control system is based on an instruction list language.

28. The method as claimed in claim 20, wherein the programming language of the control system is based on an structured controlled language.

29. The method as claimed in claim 20, wherein the identification parameters are transmitted by the operating system to the application program based upon a result of the determination of the identification parameters sent to the operating system.
